(19) United States
(12) Patent Application Publication
(10) Pub. No.: US 2026/0219800 A1
(43) Pub. Date: Jul. 30, 2026

(54) VOLTAGE ADJUSTMENT BASED ON MEMORY DEVICE TEMPERATURE PROFILING

(71) Applicant: Microchip Technology Incorporated, Chandler, AZ (US)

(72) Inventors: Salvatrice Scommegna, Cornate D'Adda (IT); Pitamber Shukla, San Jose, CA (US); Hichem Belhadj Mohamed, Loomis, CA (US); Nian Niles Yang, Mountain View, CA (US)

(73) Assignee: Microchip Technology Incorporated, Chandler, AZ (US)

(21) Appl. No.: 19/224,032

(22) Filed: May 30, 2025

Related U.S. Application Data
(60) Provisional application No. 63/751,088, filed on Jan. 29, 2025.

(51) Int. Cl. G06F 3/06

(52) U.S. Cl. CPC G06F 3/0653; G06F 3/0604; G06F 3/0679

(57) ABSTRACT

A data storage system includes, a memory device including a virtual block, non-transitory computer readable media storing instructions thereon, and at least one processor. The instructions, when executed by the at least one processor, cause the at least one processor to: measure a program temperature associated with the virtual block; measure a read temperature associated with the virtual block; determine, based at least in part on the measured program temperature and the measured read temperature, a cross-temperature condition; and based on the determined cross-temperature condition, determine an adjusted voltage. The adjusted voltage includes one or more of: an adjusted pass through voltage, an adjusted bit line bias voltage, or an adjusted source line voltage.

### CROSS-REFERENCE TO RELATED APPLICATIONS

The current patent application claims the benefit under 35 U.S.C. § 119(e) of the priority date of U.S. Provisional Application Ser. No. 63/751,088; titled “VPASSR, BITLINE BIAS VOLTAGE, AND/OR SOURCE LINE VOLTAGE ADJUSTMENT BASED ON NAND TEMPERATURE PROFILING TO COMPENSATE FOR CROSS-TEMPERATURE”; and filed Jan. 29, 2025. The Provisional Application is hereby incorporated by reference, in its entirety, into the current patent application.

### TECHNICAL FIELD

Various examples of the present disclosure relate to systems and methods for adjusting one or more voltages based on temperature profiling of a memory device to compensate for cross-temperature effects.

### BACKGROUND

Cross-temperature conditions in memory devices can occur when an operating temperature associated with programming data is different than an operating temperature associated with reading data. Read voltage thresholds of cells in the memory device may be different under different temperature conditions. Cross-temperature conditions may cause an increase in errors produced during read operations, due to the changing read voltage thresholds.

This background discussion is intended to provide information related to the present invention which is not necessarily prior art.

### SUMMARY OF THE INVENTION

According to various examples of the present disclosure, a data storage system includes a memory device including a virtual block (VB), non-transitory computer readable media storing instructions thereon, and at least one processor. The instructions, when executed by the at least one processor, cause the at least one processor to: measure a program temperature associated with the VB; measure a read temperature associated with the VB; determine, based at least in part on the measured program temperature and the measured read temperature, a cross-temperature condition; and based on the determined cross-temperature condition, determine an adjusted voltage. The adjusted voltage includes one or more of an adjusted pass through voltage (Vpassr), an adjusted bit line (BL) bias voltage, or an adjusted source line (SL) voltage.

According to various examples of the present disclosure, a computer-implemented method includes: measuring a program temperature associated with a VB; measuring a read temperature associated with the VB; determining, based at least in part on the measured program temperature and the measured read temperature, a cross-temperature condition; and based on the determined cross-temperature condition, determining an adjusted voltage. The adjusted voltage includes one or more of: an adjusted Vpassr, an adjusted BL bias voltage, or an adjusted SL voltage.

According to various examples of the present disclosure, non-transitory computer readable media includes instructions stored thereon, that, when executed by at least one processor, cause the at least one processor to: measure a program temperature associated with a VB; measure a read temperature associated with the VB; determine, based at least in part on the measured program temperature and the measured read temperature, a cross-temperature condition; and based on the determined cross-temperature condition, determine an adjusted voltage. The adjusted voltage includes one or more of: an adjusted Vpassr, an adjusted BL bias voltage, or an adjusted SL voltage.

This summary is not intended to identify essential features of the examples, and is not intended to be used to limit the scope of the claims. These and other aspects of the present examples are described below in greater detail.

### BRIEF DESCRIPTION OF THE DRAWINGS

FIG. 1 illustrates an example system for adjusting one or more voltages based on temperature profiling;

FIG. 2 illustrates an example computing system configured to perform operations in accordance with the various examples of the present disclosure;

FIG. 3 illustrates an example non-volatile memory (NVM) media of the system of FIG. 1;

FIG. 4 illustrates an example physical memory block of the NVM media of FIG. 3;

FIG. 5A illustrates a graph of voltage thresholds corresponding to various programming states of a triple level cell (TLC) wordline when a program temperature is greater than a read temperature;

FIG. 5B illustrates a graph of voltage thresholds corresponding to various programming states of a TLC wordline when a read temperature is greater than a program temperature;

FIG. 6 illustrates a logical structure of a memory device in accordance with various examples of the present disclosure; and

FIG. 7 illustrates an example method for adjusting one or more voltages based on temperature profiling.

Unless otherwise indicated, the figures provided herein are meant to illustrate features of examples of this disclosure. These features are believed to be applicable in a wide variety of systems comprising one or more examples of this disclosure. As such, the figures are not meant to include all conventional features known by those of ordinary skill in the art to be required for the practice of the examples disclosed herein.

### DETAILED DESCRIPTION

In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure. Unless clearly understood or expressly identified otherwise, structures, materials, procedures, operations, and other aspects described in the context of one example may be incorporated into other examples. In the following detailed description, reference is made to the accompanying drawings, which form a part hereof and in which are shown, by way of illustration, specific examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure. Unless clearly understood or expressly identified otherwise, structures, materials, procedures, operations, and other aspects described in the context of one example may be incorporated into other examples.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

Terms of relative location and direction (e.g., above, below, left, right, upper, lower) may be used to facilitate the present descriptions of examples with reference to the figures, but unless clearly understood or expressly identified otherwise, these terms are not meant to be limiting with regard to location, direction, or overall orientation, and may, for example, change as a result of a change in overall orientation.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, operations, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples.

The term “signal” or “electronic signal” may be used to describe electrical energy conducted through an electrically conductive medium in which an electric voltage and/or an electric current varies, or may be constant, over time. An electronic signal may be an electromagnetic wave, voltage, and/or current, and may be encoded with or representative of information.

Various examples of the present disclosure may be used in single-level cell (SLC) systems, multi-level cell (MLC) systems, triple-level cell (TLC) systems, quad-level cell (QLC) systems, and penta-level cell (PLC) systems, without limitation. Applications may include consumer hard drives, high performance computing (HPC), data transfer for AI, and data center solutions (DCS), without limitation.

In various examples of the present disclosure, a data storage system may include a memory device and a controller. The memory device may store data. The data storage system may be connected to a host system. The controller may be operable to manage storage and retrieval of data between the memory device and the host system.

The host system may send a read request to the data storage system. The read request may indicate data to be retrieved from the memory device and sent back to the host system. The controller may process the read request, retrieve the data from the memory device, process the retrieved data, and send the retrieved data to the host system. The data may be read from the memory device using a threshold voltage.

Voltage thresholds of the cells may shift over time due to cross-temperature effects. As used herein, “cross-temperature” may correspond to a difference between a write temperature (e.g., an operating temperature of the memory device when or proximate in time to when data is written to cells of the memory device) and a read temperature (e.g., an operating temperature of the memory device when or proximate in time to when data is read from the cells of the memory device). When the program temperature is greater than the read temperature, the voltage thresholds may increase. When the read temperature is greater than the program temperature, the voltage thresholds may decrease.

In various examples of the present disclosure, the controller may detect a cross-temperature condition based on measured temperature values of the memory device. A cross-temperature condition may refer to a mismatch between a program temperature at which data was programmed to one or more blocks and a read temperature at which data is read or is to be read from the block(s). If the read temperature is significantly different (e.g., a difference of at least ten (10), fifteen (15), twenty (20), or more degrees Celsius (° C.)) than the program temperature of the memory device, the controller may determine a cross-temperature condition associated with the block(s). For example, the program temperature may be between twenty (20) and fifty (50)° C., without limitation, and a cross-temperature condition may correspond to an anticipated or actual read temperature at least ten (10)° C. higher or lower than the program temperature. Accordingly, the controller may adjust one or more voltages utilized during one or more read operations to compensate for the determined cross-temperature condition.

In various examples, the one or more voltages may include a pass-through voltage (Vpassr), a bitline (BL) bias voltage, and/or a source line (SL) voltage. One or more of these voltages may be adjusted according to detected cross-temperature conditions.

Broadly, Vpassr is a voltage that passes directly through a circuit, from input to output, as if there were zero (0) impedance in the circuit (e.g., as if a wire were shorting the input to the output). In NAND flash, Vpassr may be applied to unselected wordlines (WLs) of a block of a NAND flash device during a read operation. Application of the Vpassr may ensure the unselected WLs are “ON,” or working/operating at the value of the applied Vpassr. This may enable data from one or more cells of a selected WL (e.g., the WL of the block being read that is receiving a read voltage, Vread) to be transmitted via bitlines (BLs) of the block being read. Vpassr is typically greater than Vread. Vpassr is also typically greater than the highest threshold voltage corresponding to a programmed state (e.g., greater than the highest threshold voltage corresponding to binary ‘101’ in a TLC).

Broadly, a BL bias voltage is a voltage applied to a BL to activate that BL. The BL bias voltage may enable a string current to flow through a string of cells connected that BL. Increasing the BL bias voltage may increase the string current, and decreasing the BL bias voltage may decrease the string current.

Broadly, a SL voltage is a common ground (or reference) voltage connected to the sources of all cells in a block. Accordingly, increasing the SL may decrease a string current for each string of cells corresponding to each BL of the block, and decreasing the SL may increase the string current.

Accordingly, the adjustment of Vpassr, BL bias voltage, and/or SL voltage to compensate for cross-temperature conditions may reduce an amount of time used to read data from the memory device compared to alternative approaches which may employ a background read positioning (BRP) algorithm or a read retry (RR) algorithm in response to detecting an increased number of errors. The BRP and RR algorithms require a large number of read operations, consuming significant resources (e.g., power and time).

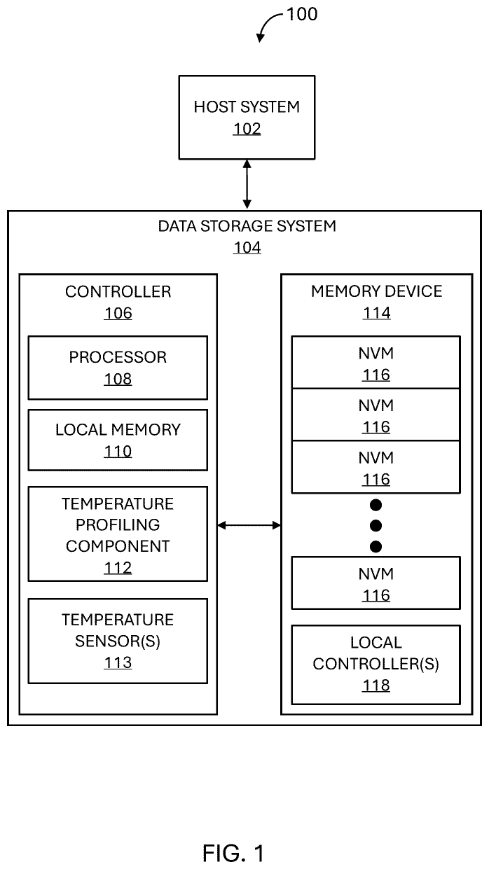

FIG. 1 illustrates an example system 100 including a host system 102 and a data storage system 104. The data storage system 104 includes include a controller 106 and a memory device 114. The controller 106 includes a processor 108, a local memory 110, a temperature profiling component 112, and one or more temperature sensor 113. The memory device 114 includes a plurality of non-volatile memory (NVM) media 116 and one or more local controller(s) 118. In various examples, the local controller(s) 118 may include one or more temperature sensors for measuring a temperature of the memory device 114.

In various examples, a read or write request may be received from the host system 102 via a peripheral component interconnect express (PCIe) interface that connects the data storage system 104 to servers or CPUs. PCIe is a standardized interface for motherboard components. In various examples, the data storage system 104 may be connected to the host system 102 by wired or wireless means (e.g., through a communications network). The data storage system 104 may be connected to more than one host system 102, such as in a multi-tenant environment, without limitation.

The controller 106 may use logical block addresses (LBAs) and physical block addresses (PBAs) to facilitate access for data storage in and retrieval from the NVM media 116. LBAs are an abstraction to allow the operating system to interact with the NVM media 116, and PBAs represent the actual hardware locations within the NVM media 116. To facilitate interacting with the NVM media 116, the controller 106 may create an entry or record that assigns an LBA to a PBA. To keep track of all such LBA-to-PBA assignments, the controller 106 may use a logical-to-physical (L2P) mapping table. The L2P table may be uploaded to the local memory 110 so that it can be more quickly accessed and updated by the controller 106. In various examples, the local memory 110 may include a synchronous dynamic random access memory (SDRAM), without limitation.

When a data request is received from the host system 102, the controller 106 references the L2P mapping table to determine the PBA within the NVM media 116 corresponding to a desired LBA. Once the PBA is determined, the controller 106 accesses the appropriate NVM media 116 to write or read the data. Access to the NVM media 116 may be via a flash physical (PHY) interface. The controller 106 may employ an error correction code (ECC) operation during encoding and decoding data to detect and correct errors and enhance data integrity. Additionally, the memory device 114 may support a direct memory access (DMA) operation enabling data to be written from the host system 102 directly to the NVM media 116 and read from the NVM media 116 directly to the host system 102. Certain commands may be issued to the controller 106 or the local controller(s) 118 using the host command layer, or non-volatile memory express management interface (NVMe-MI).

In various examples, the data storage system 104 may be a solid state drive (SSD), and the NVM media 116 may be NAND-based flash memory. It would be appreciated by one of ordinary skill in the art that other memory devices (e.g., NOR flash memory, random access memory, and the like) may be utilized in the various examples described herein without departing from the spirit of the present disclosure.

In various examples, the controller 106 may receive a write request from the host system 102. The write request may include user data to be written to one or more of the NVM media 116 of the memory device 114. The user data may include, for example, media (e.g., photos, videos, and/or audio), system information data, application data, sensor data, document data, recordkeeping data, machine learning/artificial intelligence data, gaming system data, data pertaining to internal operations of the host system, and the like, without limitation.

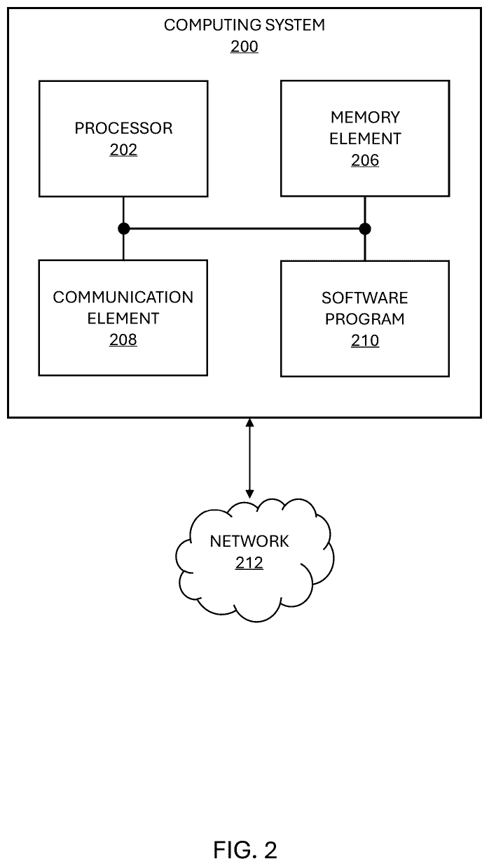

FIG. 2 illustrates a computing system 200 connected to a communication network 212. The computing system 200 may include at least one processor 202, at least one memory element 206, a communication element 208, and a software program 210. In various examples, the computing system 200 may be a host system (e.g., the host system 102 of FIG. 1), a data storage system (e.g., the data storage system 104 of FIG. 1), and/or another computing device configured to perform some and/or all operations of the various examples of the present disclosure, without limitation.

The software program 210 may be configured with instructions for performing and/or enabling performance of at least some of the steps set forth herein. In an example, the software program 210 comprises instructions stored on computer-readable media of memory element 206. In various examples, the software program 210 may include instructions for performing operations of the temperature profiling component 112 discussed with reference to FIG. 1.

The communication network 212 generally allows communication between the computing system 200 and another computing device, such as between a remote host system (e.g., the host system 102), a local host system, and/or a data storage system (e.g., the data storage system 104 of FIG. 1), without limitation.

The communication network 212 may include the Internet, cellular communication networks, local area networks, metro area networks, wide area networks, cloud networks, plain old telephone service (POTS) networks, and the like, or combinations thereof. The communication network 212 may be wired, wireless, or combinations thereof and may include components such as modems, gateways, switches, routers, hubs, access points, repeaters, towers, and the like. The computing system 200 may, for example, connect to the communication network 212 either through wires, such as electrical cables or fiber optic cables, or wirelessly, such as RF communication using wireless standards such as cellular 2G, 3G, 4G or 5G, Institute of Electrical and Electronics Engineers (IEEE) 802.11 standards such as WiFi, IEEE 802.16 standards such as WiMAX, Bluetooth™, or combinations thereof.

The communication element 208 generally allows communication between the computing system 200 and the communication network 212. The communication element 208 may include signal or data transmitting and receiving circuits, such as antennas, amplifiers, filters, mixers, oscillators, digital signal processors (DSPs), and the like. The communication element 208 may establish communication wirelessly by utilizing radio frequency (RF) signals and/or data that comply with communication standards such as cellular 2G, 3G, 4G or 5G, Institute of Electrical and Electronics Engineers (IEEE) 802.11 standard, such as WiFi, IEEE 802.16 standard, such as WiMAX, Bluetooth™, or combinations thereof. In addition, the communication element 208 may utilize communication standards such as ANT, ANT+, Bluetooth™ low energy (BLE), the industrial, scientific, and medical (ISM) band at 2.4 gigahertz (GHz), or the like. Alternatively, or in addition, the communication element 208 may establish communication through connectors or couplers that receive metal conductor wires or cables, like Cat 6 or coax cable, which are compatible with networking technologies such as ethernet. In certain examples, the communication element 208 may also couple with optical fiber cables. The communication element 208 may be in communication with the processor 202 and/or the memory element 206.

The memory element 206 may include electronic hardware data storage components such as read-only memory (ROM), programmable ROM, erasable programmable ROM, random-access memory (RAM) such as static RAM (SRAM) or dynamic RAM (DRAM), solid state drives (SSDs), cache memory, hard disks, floppy disks, optical disks, flash memory, thumb drives, universal serial bus (USB) drives, or the like, or combinations thereof. In some examples, the memory element 206 may be embedded in, or packaged in the same package as, the processor 202. The memory element 206 may include, or may constitute, a “computer-readable medium.” The memory element 206 may store the instructions, code, code segments, software, firmware, programs, applications, apps, services, daemons, or the like that are executed by the processor 202. In various examples, the memory element 206 may store the software applications/program 210. The memory element 206 may also store settings, data, documents, sound files, photographs, movies, images, databases, and the like. In various examples, the memory element 206 may include a first memory component (e.g., the local memory 110 of FIG. 1) and one or more SSDs (e.g., the memory device 114 of FIG. 1).

The processor 202 may include electronic hardware components such as processors. The processor 202 may include digital processing unit(s). The processor 202 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processor 202 may generally execute, process, or run instructions, code, code segments, software, firmware, programs, applications, apps, processes, services, daemons, or the like. For instance, the processor 202 may execute the software applications/program 210. The processor 202 may also include hardware components such as finite-state machines, sequential and combinational logic, and other electronic circuits that can perform the functions necessary for the operation of the current disclosure. The processor 202 may be in communication with the other electronic components through serial or parallel links that include universal busses, address busses, data busses, control lines, and the like.

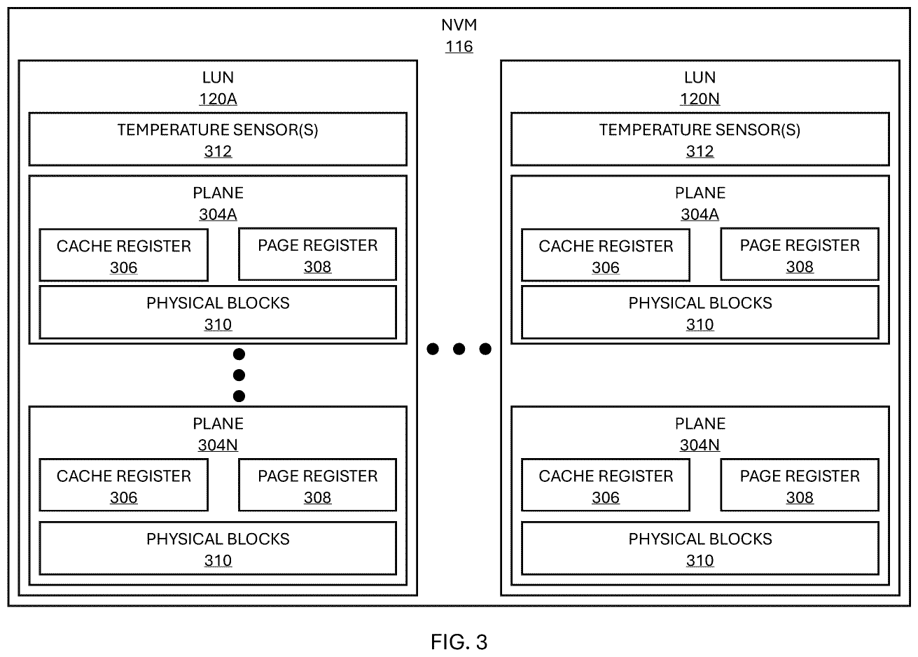

Turning to FIG. 3, the NVM media 116 may respectively include a plurality of dies. In various examples, the NVM media 116 may respectively include two (2), four (4), eight (8), sixteen (16), twenty four (24), thirty two (32), or more dies, without limitation. One or more dies of each NVM 116 may correspond to a logical unit (LUN). Each NVM 116 may include LUNs 120a, . . . 120n. Each LUN 120a, . . . 120n may include a plurality of planes 304a, . . . 304n. Each LUN 120a, . . . 120n may include, for example, four (4), six (6), eight (8), or more planes, without limitation.

Each plane may include a cache register 306, a page register 308, and a plurality of physical memory blocks 310. In various examples, the controller 106 may write incoming data to more than one NVM media 116 in parallel. The NVM media 116 may write incoming data to more than one LUN in parallel.

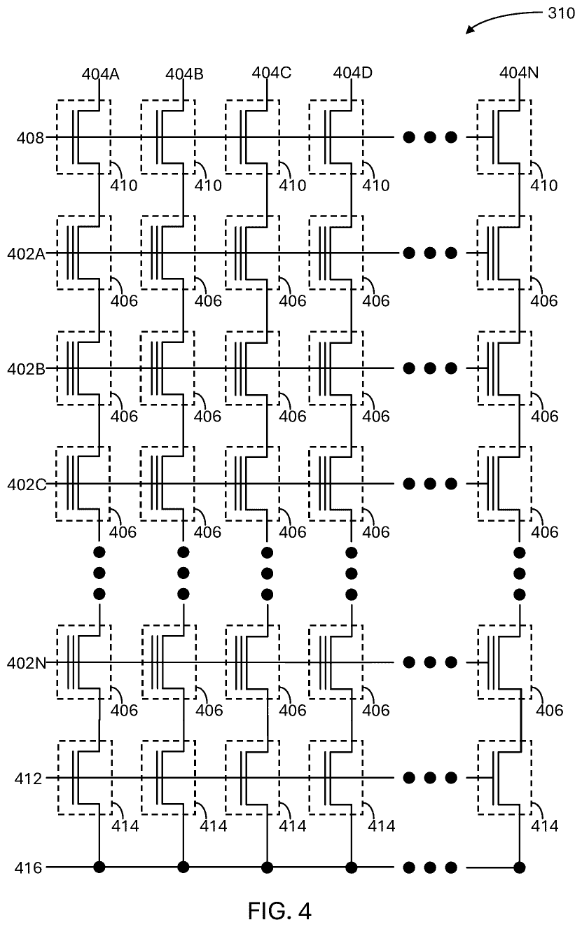

When data is written to or retrieved from the NVM media 116, the data may be temporarily stored in one of the cache register 306 and the page register 308. Each physical memory block 310 may include a set of pages (as described in connection with FIG. 4 below). The cache register 306 and the page register 308 may respectively have an equivalent data capacity of one page. Accordingly, data to be written to a first page may be temporarily stored in the cache register 306 while data to be written to another page may be temporarily stored in the page register 308. Data to be read from a first page may be retrieved and temporarily stored in the cache register 306 while data to be read from another page may be stored in the page register 308. Accordingly, the cache register 306 and page register 308 enable double buffering of data to reduce data programming and read times.

Each LUN may include one or more temperature sensor(s) 312. The temperature sensor(s) 312 may measure a temperature of the physical blocks 310 during or otherwise in connection with (e.g., proximate in time to) various operations (e.g., read and write operations). The temperature sensor(s) 312 may be configured to measure the temperature of each block 310 individually and/or may measure the temperature of each LUN and/or the NVM 116, without limitation. In various examples, the temperature sensor(s) 312 may be located within respective ones the LUNs of each NVM. In some examples, the temperature sensor(s) 312 may be integral to planes 304A . . . 304N and/or the physical blocks 310.

The temperature sensor(s) 312 may send measured temperature values to the local controller(s) 118, the processor 108, and/or the temperature profiling component 112 for processing. Measured temperature values may be stored in one or more of the NVM 116 and/or the local memory 110. In various examples, the temperature sensor(s) 312 and the temperature sensor(s) 113 may include thermistors, resistance temperature detectors, thermocouples, and/or digital (e.g., integrated circuit-based) temperature sensors, and the like, or a combination thereof.

Turning to FIG. 4, each of the physical memory blocks 310 includes a plurality of wordlines (WLs) 402A, 402B, 402C, . . . 402N, a plurality of bit lines (BLs) 404A, 404B, 404C, 404D, . . . 404N, a plurality of cells 406, a string select line 408, string select transistors 410, a ground select line 412, ground select transistors 414, and a source line (SL) 416. In various examples, a page may be defined as a row of cells connected to the same WL (e.g., the cells 406 connected to the WL 402A are collectively referred to as a “page”). Each page may include a plurality of cells 406. Each cell 406 may include a transistor having a gate, a source, and a drain. Data bits may be written to the cells 406 on a page-by-page basis. Data may be erased from the plurality of cells 406 on a physical memory block 310 basis.

Generally, each WL is an electrical conductor that is electrically connected to control gates of the cells in a respective row of cells. Each WL may convey an electronic signal that, according to its voltage level, selects a row (or page) of cells. (Each WL 402A, 402B, 402C, . . . 402N may be drawn as a horizontal line shown in FIG. 4.) When a specific WL is activated (e.g., when a read voltage is applied), the cells connected to that WL are selected for reading or writing. In NAND flash memory, cells are organized into a series of strings, with each string being connected to one of a plurality of BLs, wherein each BL is an electrical conductor that is electrically connected to the drains of cells in a column of cells. Each BL may convey an electronic signal that, according to its voltage level, may enable data transfer to and from the cells of a selected WL during read and write operations. (Each BL 404A, 404B, 404C, 404D . . . 404N may be drawn as a vertical line shown in FIG. 4.) During a read operation, the voltage on the BL reflects a state of the selected cell(s). Accordingly, the voltage and/or current of the BL may be measured and/or determined to determine the value of the data in the selected cells.

In various examples, the cells 406 may include single-level cells (SLCs), multi-level cells (MLCs), triple-level cells (TLCs), quadruple-level cells (QLCs), and/or penta-level cells (PLCs), without limitation. Accordingly, the WLs 402A, 402B, 402C, . . . 402N may be SLC wordlines, MLC wordlines, QLC wordlines and/or PLC wordlines, without limitation. In an example, a TLC wordline may include a lower page, a middle page, and an upper page. The lower page, middle page, and upper page may correspond to a page including a row of TLCs. The TLC wordline may be activated to write data to each of the upper, middle, and lower pages. Accordingly, an SLC wordline may include one (1) page, an MLC wordline may include two pages (2), a TLC wordline may include three (3) pages, a QLC wordline may include four (4) pages, and a PLC wordline may include five (5) pages.

The string select line 408 is an electrical conductor that is electrically connected to the gates of the string select transistors 410. The string select line 408 may convey an electronic signal that, according to its voltage level, selects one or more of the string select transistors 410. The string select transistors 410, when activated, may connect a string (or column) of cells 406 to a corresponding one of the bitlines 404A, 404B, 404C, 404D, . . . 404N.

In various examples, a BL bias voltage may be supplied to one or more of the BLs 404A, 404B, 404C, 404D, . . . 404N (e.g., at an electrical contact (not shown) that is electrically connected to the drain of a corresponding one of the string select transistors 410). The BL bias voltage supplied to an activated BL may enable current to flow through a string of cells connected to that BL. Increasing the BL bias voltage applied to one of the BLs may increase a string current of the cells connected to that BL, and decreasing the BL bias voltage may decrease the string current.

Similarly, the ground select line 412 is an electrical conductor that is electrically connected to the gates of the ground select transistors 414. The ground select line 412 may convey an electronic signal that, according to its voltage level, selects one or more of the ground select transistors 414. The ground select transistors 414, when activated, may connect a string (or column) of cells 406 to the SL 416.

The SL 416 is an electrical conductor that is electrically connected to the sources of the cells 406. The SL 416 may connect each string of cells 406 to a common ground (or reference) voltage corresponding to a SL voltage. Accordingly, increasing the SL voltage may reduce a string current of each string of cells 406, and decreasing the SL voltage may increase the string current of each string of cells 406. The SL 416 may be connected to a sense amplifier (not shown), which may measure a string current (Icell) and/or voltage of the activated cells 406, thereby determining a value of the data stored in the activated cells 406.

Generally, a read voltage threshold may correspond to a reference voltage used when reading data from a cell. During a read operation, a read voltage may be applied to a WL corresponding to a page, or row of cells. In response to applying the read voltage, each cell may produce a current having a voltage value corresponding to a voltage threshold of that cell. The voltage threshold of the cells may be compared to the reference voltage to determine the value of the data in the cells. In the case of a triple-level cell (TLC), seven (7) different reference voltages are needed to read the three (3) bits stored in the TLC. Specifically, two (2) reference voltages may be used to read a first bit from the TLC, three (3) reference voltages may be used to read a second bit from the TLC, and two (2) reference voltages may be used to read a third bit from the TLC.

During a read operation, a read voltage Vread is applied to a selected WL. A pass through voltage Vpassr may be applied to remaining ones of the WLs (e.g., the unselected WLs). A BL bias voltage may be applied to one or more BLs containing cells to be read. A SL voltage may be applied to each string of cells via the SL.

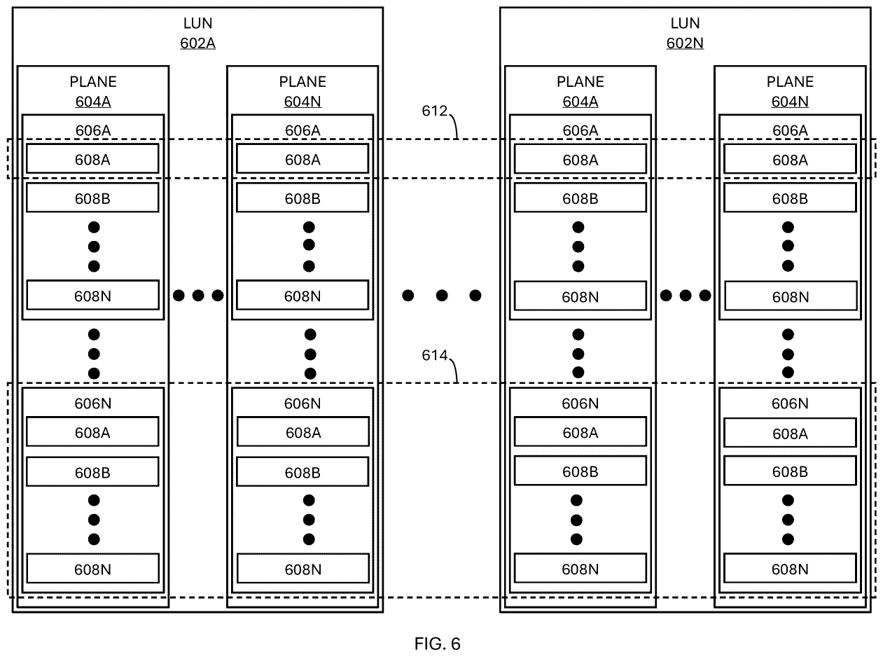

Returning to FIG. 3, in various examples, the physical blocks 310 may be organized into virtual blocks (VBs). A VB may include one physical block 310 from each plane 304A . . . 304N of each LUN 120A . . . 120N of each NVM 116 of the memory device 114. Each VB may include a set of virtual wordlines (VWL). Each VWL may include a set of WLs (e.g., a VWL may include one (1) WL from each physical block 310 of a VB). In various examples, the data processing and programming operations of this disclosure may be performed on a VB/VWL basis. Also or alternatively, the data processing and programming operations may be performed on a physical block/WL basis without departing from the spirit of the present disclosure. VBs/VWLs are described in more detail below in connection with FIG. 6.

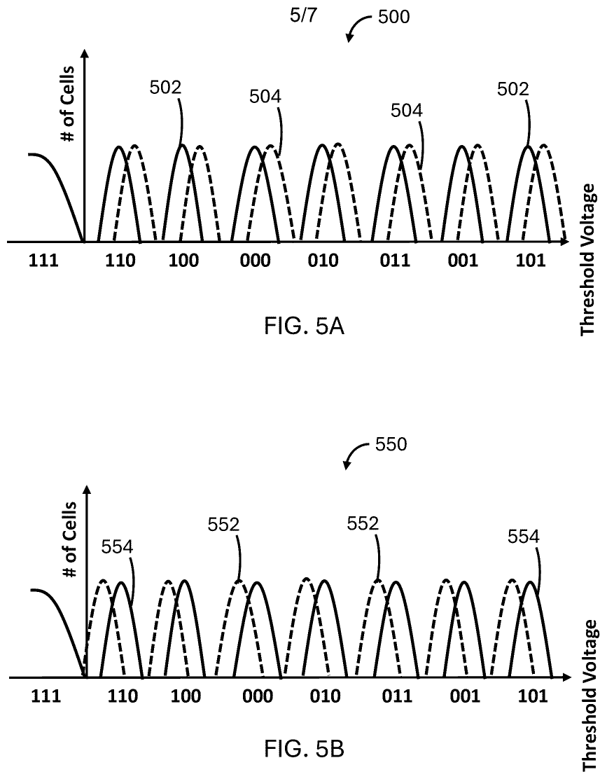

FIGS. 5A and 5B illustrate voltage thresholds corresponding to various programming states of a TLC wordline of the memory device 114 under different temperature conditions. Generally, each programming state may correspond to a read voltage threshold. Each read voltage threshold may include a range of voltage values. If a read temperature (e.g., an operating temperature of the memory device at the time of a read operation) is greater than a program temperature (e.g., the operating temperature of the memory device at the time of a program operation), the read voltage thresholds may be decreased. Inversely, if the read temperature is less than the program temperature, the read voltage thresholds may be increased. When the operating temperature increases above a typical operating temperature range, average temperature, or rated temperature, the decreased voltage thresholds may cause a significant increase in errors as the voltage thresholds fall below an expected voltage range. When the operating temperature decreases below a typical operating temperature range, average temperature, or rated temperature, the increased voltage thresholds may cause a significant increase in errors as the voltage thresholds increase above an expected voltage range.

Turning more specifically to FIG. 5A, a graph 500 of voltage thresholds is illustrated corresponding to various programming states of a TLC wordline associated with a program temperature greater than a read temperature. The voltage thresholds include voltage thresholds 502 and voltage thresholds 504. The solid line voltage thresholds 502 correspond to the voltage thresholds of the TLC wordline when data is programmed to the TLC wordline at a first temperature. The broken line voltage thresholds 504 correspond to the voltage thresholds of the TLC wordline when data is read from the TLC wordline at a second temperature. The first temperature is greater than the second temperature. The voltage thresholds of the TLC wordline may increase after programming as the temperature decreases. The increased voltage thresholds may increase a resistance of the cells in the TLC wordline, thereby causing a decrease in a string current (Icell) of the cells during a read operation.

Turning to FIG. 5B, a graph 550 of voltage thresholds is illustrated corresponding to various programming states of a TLC wordline associated with a read temperature greater than a program temperature. The voltage thresholds include voltage thresholds 552 and voltage thresholds 554. The solid line voltage thresholds 554 correspond to the voltage thresholds of the TLC wordline when data is programmed to the TLC wordline at a first temperature. The broken line voltage thresholds 552 correspond to the voltage thresholds of the TLC wordline when data is read from the TLC wordline at a second temperature. The second temperature is greater than the first temperature. The voltage thresholds of the TLC wordline may decrease after programming as the temperature increases. The decreased voltage thresholds may decrease a resistance of the cells in the TLC wordline, thereby causing Icell to increase during a read operation.

FIG. 6 illustrates a logical structure of a memory device (e.g., the memory device 114 of FIG. 1). The logical structure includes a plurality of LUNs 602A . . . 602N. Each LUN 602A . . . 602N includes a plurality of planes 604A . . . 604N. Each plane 604A . . . 604N includes physical blocks 606A . . . 606N. Each block 606A . . . 606N includes WLs 608A, 608B, . . . 608N. It would be appreciated by one of ordinary skill in the art that the memory device may include any number of LUNs, planes, blocks, and WLs, and the number of LUNs, planes, blocks, and WLs may not be the same as each other (e.g., an NVM die may have many more WLs than planes).

Respective ones of the WLs 608A may be organized into a virtual WL (VWL) 612. The VWL 612 may include the WL 608A from a block 606A of each of the planes 604A . . . 604N of each of the LUNs 602A . . . 602N. In some examples, the WLs of a VWL may not be in the same location of each block and/or plane (e.g., a VWL may include one of the WLs 608A from a first plane, one of the WLs 608B from another plane, and so on) without departing from the scope of the present disclosure. The number of WLs in a VWL may be the same as the number of WLs in a physical block.

Respective ones of the blocks 606A . . . 606N may be organized into a virtual block (VB) 614. The VB 614 may include the block 606A . . . 606N corresponding to each of the planes 604A . . . 604N of each of the LUNs 602A . . . 602N. In some examples, the blocks 606A . . . 606N of a VB 614 may be in different locations of each plane 604A . . . 604N (e.g., one of the blocks 606A from a first plane, one of the blocks 606N from another plane, and so on) without departing from the scope of the present disclosure. The number of blocks in a VB may be the same as the number of blocks in a plane. The VB 614 may additionally include a plurality of VWLs, such as a first VWL including the WL 608A of each of the blocks 606N, a second VWL including the WL 608B of each of the blocks 606N, and so on.

In various examples, data may be written to the VWL 612 and/or the VB 614 over a period of time. For example, data may be written to the WL 608A of the first plane 604A of the LUN 602A at a first time, data may be written to the WL 608A of the plane 604N of the LUN 602A at a second time following the first time, and data may be written to the WL 608A of the plane 604N of the LUN 602N at a third time following the second time. Accordingly, operating temperatures of the memory device may vary when data is written to and/or read from different WLs/blocks at different times.

Returning to FIG. 1, the NVM 116 may be organized into a plurality of VBs (e.g., the VB 614 of FIG. 6). The temperature profiling component 112 may monitor operating temperatures of each VB. Monitoring the temperatures may include receiving and recording operating temperatures from the temperature sensor(s) 113, the temperature sensor(s) 312 of the NVM 116, and/or the local controller(s) 118 of the memory device 114.

In various examples, one or more measured temperature values for a VB may be recorded in connection with performing an operation (e.g., a read and/or program operation) and/or periodically (e.g., at regular and/or pre-determined intervals). The VB may include a plurality of physical blocks (e.g., as described in connection with FIG. 6). The measured temperature(s) associated with the VB may include one or more temperatures of each block of the VB, a maximum block temperature (e.g., the temperature of the block associated with the highest measured temperature), a minimum block temperature (e.g., the temperature of the block associated with the lowest measured temperature), an average block temperature and/or a median block temperature, and the like.

In various examples, any type of measured temperature—whether a discrete or average temperature, and whether taken at the level of a VB or block, for example—may be recorded in connection with an operation (e.g., a read or write operation). The temperature measurement(s) may be prompted or initiated based on initiation or anticipated initiation of the operation, and/or may be taken at regular intervals and associated with the operation based on, for example, temporal proximity (e.g., based on comparison of timestamps or the like associated with the operation and the temperature measurement).

In various examples, the temperature profiling component 112 may receive raw or discrete temperature values for each block and calculate the maximum block temperature, the minimum block temperature, the average block temperature and/or the median block temperature. The temperature profiling component 112 may store the measured temperature values in a memory (e.g., the local memory 110 and/or one of the NVM 116). The measured temperature(s) may be mapped to the VB from which the measurements were taken. The measured temperature(s) and the VB mapping may be stored together in a table.

In various examples, the temperature profiling component 112 may process the measured temperature(s) and generate temperature profiles for each VB of the memory device. The temperature profiles may include historical measured temperatures, current measured temperatures, error information, and other statistical information (e.g., number of program/erase cycles, usage information, and the like) for each VB. The temperature profiles may include temperature information (e.g., minimum temperature, maximum temperature, average temperature, median temperature, and the like) and other statistical information (e.g., error information, number of program/erase cycles, usage information, and the like) for the physical blocks encompassing each VB. The temperature profiling component 112 may utilize temperature profiles to determine cross-temperature conditions and adjust one or more voltages (e.g., Vpassr, BL bias voltage, and/or SL voltage). For example, before performing a read operation, the adjusted voltage(s) may be determined based on a comparison of a read (current) temperature and a program temperature of one or more blocks of the VB containing data to be read.

When a read and/or write operation is performed on the VB, the temperature profiling component 112 may retrieve the measured temperature(s) and receive, measure and/or record new measured temperature(s) for the VB. The temperature profiling component 112 may compare the retrieved measured temperature(s) (e.g., a program temperature) with the new measured temperature(s) (e.g., a read or anticipated read temperature) to determine whether a cross-temperature condition is present. If a cross-temperature condition is present, the temperature profiling component 112 may determine one or more adjusted voltages for performing a read and/or write operation on the VB to compensate for the determined cross-temperature condition.

Adjusting one or more voltages based on detected cross-temperature conditions may prevent errors that would otherwise occur using previous and/or default voltages. Accordingly, cross-temperature compensation may improve quality of service (QoS) by reducing read/program times, improving reliability of the memory device by reducing errors, and reducing a number of program/erase cycles that would otherwise be necessary to correct errors caused by cross-temperature, thus extending the lifetime of the memory device.

In various examples, instructions for executing the temperature profiling component 112 may be stored in the local memory 110. Some or all functions of the temperature profiling component 112 may be executed by the processor 108, the temperature sensor(s) 113, the local controller(s) 118, other circuitry of the controller 106 and/or the memory device 114, and/or a combination thereof.

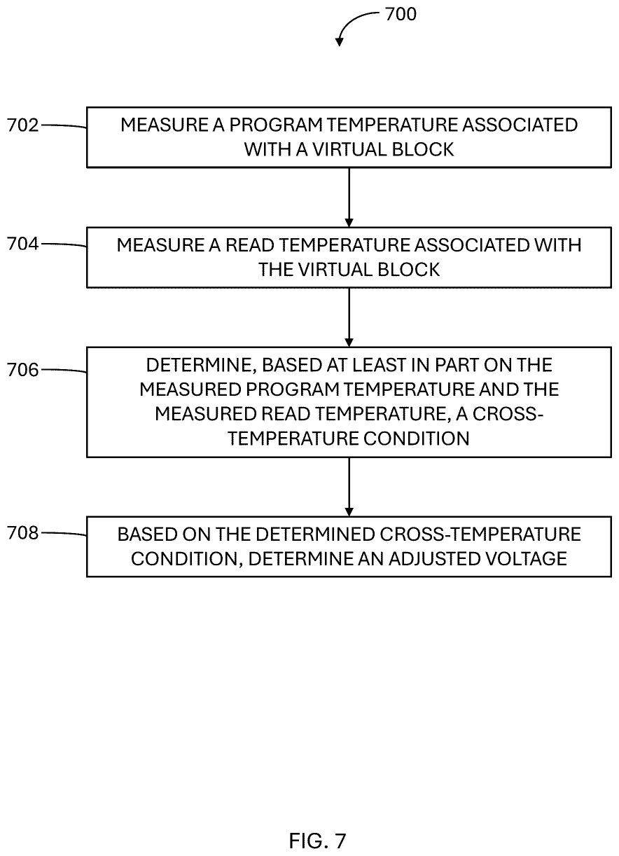

Additional operations and details associated with determining cross-temperature conditions and adjusting one or more voltages are described in greater detail below in connection with the method 700 of FIG. 7. In various examples, the temperature profiling component 112 may perform any and/or all operations described below with reference to FIG. 7.

Through hardware, software, firmware, or various combinations thereof, any of the processing elements (e.g., the controller 106 and/or local controller(s) 118 of FIG. 1 and/or the processing element 202 of FIG. 2) may—alone or in combination with other processing elements—be configured to perform the operations of examples of the present disclosure. The examples described herein in connection with the attached drawing figures are intended to describe aspects of the disclosure in sufficient detail to enable those skilled in the art to practice the disclosure. Other examples can be utilized and changes can be made without departing from the scope of the present disclosure. The system may include additional, less, or alternate functionality and/or device(s), including those discussed elsewhere herein. The above and below detailed description is, therefore, not to be taken in a limiting sense. The scope of the present disclosure is defined only by the appended claims, along with the full scope of equivalents to which such claims are entitled, unless otherwise expressly stated and/or readily apparent to those skilled in the art from the description.

FIG. 7 illustrates an example method 700 for detecting and adjusting for a cross-temperature condition. The method 700 may be performed by a controller (e.g., the controller 106 and/or the temperature profiling component 112 of FIG. 1) of a data storage system (e.g., the data storage system 106 of FIG. 1). The data storage system may additionally include a memory device (e.g., the memory device 114 of FIG. 1). The memory device may include a virtual block (e.g., the VB 614 of FIG. 6). The data storage system may be connected to a host system (e.g., the host system 102 of FIG. 1).

At operation 702, a program temperature associated with the VB is measured. The program temperature may be measured by one or more temperature sensors internal to the memory device (e.g., the temperature sensor(s) 312 of FIG. 3) and/or one or more temperature sensors of the controller (e.g., the temperature sensor(s) 113 of FIG. 1). In various examples, the program temperature may include an aggregation of program temperature values measured in connection with one or more program operations associated with the VB. Various temperature metrics (e.g., average program temperature, maximum program temperature, minimum program temperature, and the like) may be calculated from the aggregation of program temperature values.

Alternatively or additionally, the measured program temperature may include a single temperature measurement performed in connection with a program operation corresponding to the VB. The single temperature measurement may include a temperature value that was measured before, during, or subsequent to the program operation (e.g., within a range of time encompassing the program operation, such as a pre-determined range of time) and/or may include an average temperature of the blocks of the VB, a maximum program temperature, or a minimum program temperature. The average, minimum, or maximum temperature may be calculated by circuitry internal to the memory device (e.g., the local controller(s) 118) and/or the controller.

In various examples, the measured program temperature may be stored in a temperature profile of the VB. The measured program temperature may be stored along with previously stored temperatures of the VB. In various examples, the temperature profile may include a rolling average of temperature values, where the rolling average is updated each time a new temperature measurement is received. The temperature profile may include historical temperature data (e.g., temperature values over time), current temperature data, and other statistical information (e.g., error information, status information, usage information, program/erase cycle count) for the VB. In various examples, each VB and/or block may be allocated a program temperature portion of memory, and storage of the most recent program temperature value may evict or displace a previous program temperature value corresponding to a previous program operation.

Each block of the VB may be associated with a different program temperature value. For example, a first block of the VB may be programmed at a first time and a second block of the VB may be programmed at a second time following the first time. The program temperature of the first block may correspond to a temperature of the first block at or near the first time. The program temperature of the second block may correspond to a temperature of the second block at or near the second time. Accordingly, the program temperature for the VB may include an average block temperature, a maximum block temperature (e.g., the program temperature having a highest temperature value among the individual program temperatures of the blocks), and/or a minimum block temperature (e.g., the program temperature having a lowest temperature value among the individual block temperatures of the blocks), in each case considering first and second temperatures corresponding to the first and second block program operations.

At operation 704, a read temperature associated with the VB is measured. The read temperature may be measured by the temperature sensor(s) internal to the memory device and/or the temperature sensor(s) of the controller. In various examples, the read temperature may include an aggregation of read temperature values measured in connection with one or more read operations associated with the VB. Various temperature metrics (e.g., average read temperature, maximum read temperature, minimum read temperature, and the like) may be calculated from the aggregation of read temperature values. In various examples, the measured read temperature may be stored in the temperature profile of the VB.

Alternatively or additionally, the measured read temperature may include a single temperature measurement performed in connection with a read operation corresponding to the VB. The single temperature measurement may include a temperature value that was measured prior to the read operation. The read temperature measurement may include an average temperature of the blocks of the VB, a maximum read temperature, or a minimum read temperature. The average, minimum, or maximum temperature may be calculated by circuitry internal to the memory device (e.g., the local controller(s) 118) and/or the controller. In various examples, the measured read temperature may be taken and/or calculated in anticipation of (e.g., before) performance of the read operation, permitting voltage adjustments described below for improved performance of the read operation.

At operation 706, a cross-temperature condition is determined based at least in part on the measured program temperature and the measured read temperature. The measured read temperature may be compared to the measured program temperature to determine a temperature difference (e.g., whether the read temperature is greater than the program temperature (or vice-versa)). In various examples, the temperature difference may include a maximum difference, a minimum difference, an average difference, and/or an aggregation of respective temperature differences corresponding to each block. The temperature difference may be compared to one or more temperature criteria. If the temperature difference meets the one or more temperature criteria, a cross-temperature condition may be determined.

The one or more temperature criteria may include a temperature difference exceeding a threshold. The threshold may be about +/−five (5)° C., +/−ten (10)° C., +/−fifteen (15)° C., +/−twenty (20)° C., +/−twenty five (25)° C., or more. In various examples, the threshold may be variable based on the read and program temperatures. For example, read voltage thresholds of the VB may be less stable at higher temperatures (e.g., greater than about thirty (30)° C.) than relatively lower temperatures (e.g., around twenty five (25)° C.). Accordingly, the threshold may be increased for lower read and/or program temperatures and decreased for higher read and/or program temperatures. In some examples, the threshold may be adjusted based on whether the read temperature is higher than the program temperature.

At operation 708, an adjusted voltage is determined based on the determined cross-temperature condition. In various examples, the determination of the adjusted voltage may be coincident with or may subsume the determination of the cross-temperature condition, e.g., where the read temperature and the program temperature are analyzed to determine a voltage adjustment without an intervening discrete determination of the cross-temperature condition (i.e., the determination of the cross-temperature condition is implicit in the determination of the voltage adjustment).

Each block of the VB may include a plurality of cells. Each cell may have a corresponding threshold voltage. The threshold voltage of the cells may shift due to cross-temperature conditions. A threshold voltage shift may be determined based on the determined cross-temperature condition. The threshold voltage shift may be calculated for the VB as a whole, each block individually, or each WL of each block. Accordingly, the adjusted voltage may be determined for the VB as a whole, each block individually, or each WL of each block.

For example, a first block of the VB may be associated with a larger read/program temperature difference than a second block and, accordingly, may be associated with a larger threshold voltage shift for the second block. Accordingly, the adjusted voltage may be different for each of the first and second blocks.

The adjusted voltage may include a pass through voltage (Vpassr), a BL bias voltage and/or a SL voltage. As described throughout this disclosure, the Vpassr is a voltage applied to unselected WLs during a read operation, the BL bias voltage is a voltage applied to one or more selected BLs, and the SL voltage is a common ground (or reference) voltage connected to each cell in a block.

If the cross-temperature condition is associated with a program temperature being higher than a read temperature, the Vpassr and/or the BL bias voltage may be increased to compensate for increased read voltage thresholds (e.g., as shown in FIG. 5A) associated with the cells of the block. Increasing Vpassr and/or the BL bias voltage may cause the cells of the unselected WLs (for Vpassr) and/or selected BLs (for BL bias) to become less resistive, thereby increasing the string current. Similarly, if the cross-temperature condition is associated with a read temperature being higher than a program temperature, the Vpassr and/or BL bias voltage may be decreased to compensate for decreased read voltage thresholds (e.g., as shown in FIG. 5B) associated with the cells of the block. Decreasing the Vpassr and/or the BL bias voltage may cause the cells of the unselected WLs (for Vpassr) and/or selected BLs (for BL bias) to become more resistive, thereby decreasing the string current.

Also or alternatively, if the cross-temperature condition is associated with a program temperature being higher than a read temperature, the SL voltage may be decreased to compensate for increased read voltage thresholds (e.g., as shown in FIG. 5A) associated with the cells of the block. Decreasing the SL voltage may cause the cells of a block of the VB to become less resistive, thereby increasing the string current. Similarly, if the cross-temperature condition is associated with a read temperature being higher than a program temperature, the SL voltage may be increased to compensate for decreased read voltage thresholds (e.g., as shown in FIG. 5B) associated with the cells of the block. Increasing the SL voltage may cause the cells of the block to become more resistive, thereby decreasing the string current.

A value of the Vpassr, BL bias voltage, and/or SL voltage adjustment may be associated with estimated read voltage thresholds of the cells in the block and/or the temperature profile of the VB, and may be variable for each WL or VWL (when Vpassr is adjusted) and/or each BL (when the BL bias voltage is adjusted). For example, the read voltage thresholds of the cells may be estimated based on the determined temperature difference (e.g., for each block individually or for the VB as a whole). The estimated read voltage threshold may be compared to previous (or default) voltage thresholds to determine a voltage threshold deviation. The previous (or default) voltage thresholds may be included in the temperature profile of the VB. The Vpassr, BL bias voltage, and/or SL voltage may be adjusted in proportion to the determined voltage threshold deviation. The adjusted voltage may adjust a string current (Icell) according to the determined voltage threshold deviation such that the data may be accurately read. For example, a determination may be made that the read voltage thresholds have increased above the previous (or default) read voltage thresholds or decreased below the previous (or default) read voltage thresholds. The Vpassr, BL bias voltage, and/or SL voltage may be adjusted according to the determination.

In various examples, Vpassr may be the same for each unselected VWL/WL, may vary for each unselected VWL/WL, or may vary according to groups of unselected VWL/WLs, based on, for example, proximity to a ground select line (e.g., the ground select line 412 of FIG. 4), a source line (e.g., the source line 416 of FIG. 4), and/or a sense amplifier. Accordingly, when the Vpassr is adjusted, a value of the voltage adjustment may be the same for each unselected VWL/WL, may vary for each unselected VWL/WL, or may vary according to groups of unselected VWL/WLs, based on, for example, proximity to the ground select line, the source line, and/or the sense amplifier.

In various examples, the adjusted Vpassr may be applied on a VWL basis and/or may be applied on a WL basis. For each VWL, the adjusted Vpassr may be applied to one or more programmed unselected VWLs and/or unprogrammed unselected VWLs (e.g., all remaining unprogrammed unselected VWLs of the VB). For each block of the VB, the adjusted Vpassr may be applied to one or more programmed unselected WLs (UWLs), and/or unprogrammed UWLs (e.g., all remaining unprogrammed UWLs of the block), in any combination. In various examples, the adjusted Vpassr may be applied to one or more of the UWLs, another adjusted Vpassr may be applied to multiple other of the UWLs, and/or another Vpassr (e.g., a default or manufacturer-defined Vpassr) will be applied to still other of the UWLs, in any combination.

In various examples, the BL bias voltage may be the same for each selected BL, may vary for each selected BL, or may vary according to groups of selected BLs, based on, example, proximity to other circuitry of the memory device. When the BL bias voltage is adjusted, a value of the BL bias voltage adjustment may be the same for each selected BL, may vary for each selected BL, or may vary according to groups of selected BLs based on, for example, proximity to the other circuitry of the memory device.

In various examples, the adjusted BL bias voltage may be applied to one or more selected BLs, another adjusted BL bias voltage may be applied to multiple others of the selected BLs, and/or another BL bias voltage (e.g., a default or manufacturer-defined BL bias voltage) may be applied to still others of the selected BLs, in any combination. The adjusted BL bias voltage may be the same for each BL of respective ones of the blocks of the VB, different for each block of the VB, and/or different for different BLs within the same block of the VB, in any combination.

In various examples, the adjusted SL voltage may be applied to each block of the VB and/or individual blocks that are subject to a read operation. The adjusted SL voltage may be the same for each block of the VB, may vary for each block, or may vary according to groups of blocks based on, for example, varying read/program temperature differences of each block.

In various examples, the adjusted Vpassr, BL bias voltage, and/or SL voltage may be applied to one or more blocks of the VB individually or in combination with each other. The adjusted Vpassr may be applied to one or more blocks of the VB, the adjusted BL bias voltage may be applied to one or more the blocks of the VB, and the adjusted SL voltage may be applied to one or more blocks of the VB, in any combination.

Subsequent to determining the adjusted voltage, a read operation may be performed to read data from a selected VWL of the VB. In various examples, the read operation may be performed on only a portion of the WLs of the VWL and/or may be performed on more than one VWL of the VB. A read voltage (Vread) may be applied to the WLs of the selected VWL to activate the VWL. A Vpassr is applied to unselected VWLs of the VB. The Vpassr may include an adjusted Vpassr, which may or may not be the same for each unselected VWL, as described above. A BL bias voltage is applied to selected BLs connected to cells of the VWL. The BL bias voltage may include an adjusted BL bias voltage, which may or may not be the same for each selected BL, as describe above. A SL voltage is applied to each block of the VB. The SL voltage may include an adjusted SL voltage, which may or may not be the same for each block, as described above.

The Vpassr (or adjusted Vpassr) may be applied to one or more of the remaining (unselected) VWLs so that data may pass through the one or more remaining VWLs. The data may pass through a selected BL where it may be read.

### Feature Combinations

According to various examples of the present disclosure, a data storage system may include: a memory device may include a VB, non-transitory computer readable media storing instructions thereon, and at least one processor. The instructions, when executed by the at least one processor, cause the at least one processor to: measure a program temperature associated with the VB; measure a read temperature associated with the VB; determine, based at least in part on the measured program temperature and the measured read temperature, a cross-temperature condition; and based on the determined cross-temperature condition, determine an adjusted voltage. The adjusted voltage may include one or more of: an adjusted Vpassr, an adjusted BL bias voltage, or an adjusted SL voltage.

According to various examples of the present disclosure, a computer-implemented method may include: measuring a program temperature associated with a VB; measuring a read temperature associated with the VB; determining, based at least in part on the measured program temperature and the measured read temperature, a cross-temperature condition; and based on the determined cross-temperature condition, determining an adjusted voltage. The adjusted voltage may include one or more of: an adjusted Vpassr, an adjusted BL bias voltage, or an adjusted SL voltage.

According to various examples of the present disclosure, non-transitory computer readable media may include instructions stored thereon, that when executed by at least one processor, cause the at least one processor to: measure a program temperature associated with a VB; measure a read temperature associated with the VB; determine, based at least in part on the measured program temperature and the measured read temperature, a cross-temperature condition; and based on the determined cross-temperature condition, determine an adjusted voltage. The adjusted voltage may include one or more of: an adjusted Vpassr, an adjusted BL bias voltage, or an adjusted SL voltage.

In combination with any of the previous examples, an adjusted voltage may be an adjusted Vpassr and a VB may include a plurality of VWLs. Instructions, when executed by at least one processor may cause the at least one processor to: perform a read operation at least in part by: applying a read voltage to a first VWL of the plurality of VWLs; and applying the adjusted Vpassr to one or more remaining VWLs of the plurality of VWLs.

In combination with any of the previous examples, an adjusted voltage may be an adjusted BL bias voltage and a VB may include a plurality of VWLs and a plurality of BLs. Instructions, when executed by at least one processor may cause the at least one processor to: perform a read operation at least in part by: applying a read voltage to a first VWL of the plurality of VWLs; and applying the adjusted BL bias voltage to one or more of the plurality of BLs.

In combination with any of the previous examples, an adjusted voltage may be an adjusted SL voltage and a VB may include a plurality of VWLs and a plurality of physical blocks. Instructions, when executed by at least one processor may cause the at least one processor to:
perform a read operation at least in part by: applying a read voltage to a first VWL of the plurality of VWLs; and applying the adjusted SL voltage to one or more of the plurality of physical blocks.

In combination with any of the previous examples, a VB may include a BL. The BL may include a string of cells electrically connected in series. An adjusted voltage may adjust a string current of the string of cells.

In combination with any of the previous examples, a determination of a cross-temperature condition may include determining that a read threshold voltage associated with a VB has increased above a default read threshold voltage. An adjusted voltage to may increase a string current.

In combination with any of the previous examples, a determination of a cross-temperature condition may include determining that a read threshold voltage associated with a VB has decreased below a default read threshold voltage. An adjusted voltage to may decrease a string current.

In combination with any of the previous examples, a VB may include a plurality of physical blocks. A measured program temperature may include an aggregation of program temperature values corresponding to respective ones of the plurality of physical blocks. A measured read temperature may include an aggregation of read temperature values corresponding to respective ones of the plurality of physical blocks.

### General Considerations

In this description, references to “one embodiment”, “an embodiment”, “embodiments”, “an example”, “one example”, or “examples” mean that the feature or features being referred to are included in at least one embodiment or example of the technology. Separate references to “one embodiment”, “an embodiment”, “embodiments”, “an example”, “one example”, or “examples” in this description do not necessarily refer to the same embodiment or example and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein, unless otherwise expressly stated and/or readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as an FPGA, to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as communication elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed and substitutions made herein without departing from the scope of the invention as recited in the claims.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the disclosure as hereinafter claimed along with their legal equivalents. In addition, features from one example may be combined with features of another example while still being encompassed within the scope of the disclosure as contemplated by the inventors.

What is claimed is:

1. A data storage system comprising:
a memory device including a virtual block (VB);
non-transitory computer readable media storing instructions thereon; and
at least one processor, wherein the instructions, when executed by the at least one processor, cause the at least one processor to:
measure a program temperature associated with the VB;
measure a read temperature associated with the VB;
determine, based at least in part on the measured program temperature and the measured read temperature, a cross-temperature condition; and
based on the determined cross-temperature condition, determine an adjusted voltage, the adjusted voltage including one or more of: an adjusted pass through voltage (Vpassr), an adjusted bit line (BL) bias voltage, or an adjusted source line (SL) voltage.

2. The data storage system of claim 1, wherein the adjusted voltage is an adjusted Vpassr and the VB includes a plurality of virtual wordlines (VWLs), the instructions, when executed by the at least one processor, causing the at least one processor to:
perform a read operation at least in part by—
applying a read voltage to a first VWL of the plurality of VWLs,
applying the adjusted Vpassr to one or more remaining VWLs of the plurality of VWLs.

3. The data storage system of claim 1, wherein the adjusted voltage is an adjusted BL bias voltage and the VB includes a plurality of virtual wordlines (VWLs) and a plurality of bitlines (BLs), the instructions, when executed by the at least one processor, causing the at least one processor to:
perform a read operation at least in part by—
applying a read voltage to a first VWL of the plurality of VWLs,
applying the adjusted BL bias voltage to one or more of the plurality of BLs.

4. The data storage system of claim 1, wherein the adjusted voltage is an adjusted SL voltage and the VB includes a plurality of virtual wordlines (VWLs) and a plurality of physical blocks, the instructions, when executed by the at least one processor, causing the at least one processor to:
perform a read operation at least in part by—
applying a read voltage to a first VWL of the plurality of VWLs,
applying the adjusted SL voltage to one or more of the plurality of physical blocks.

5. The data storage system of claim 1, the VB including a bit line (BL), the BL including a string of cells electrically connected in series, the adjusted voltage to adjust a string current (Icell) of the string of cells.

6. The data storage system of claim 5, the determination of the cross-temperature condition including determining that a read threshold voltage associated with the VB has increased above a default read threshold voltage, the adjusted voltage to increase the Icell.

7. The data storage system of claim 5, the determination of the cross-temperature condition including determining that a read threshold voltage associated with the VB has decreased below a default read threshold voltage, the adjusted voltage to decrease the Icell.

8. The data storage system of claim 1, the VB including a plurality of physical blocks, the measured program temperature including an aggregation of program temperature values corresponding to respective ones of the plurality of physical blocks, the measured read temperature including an aggregation of read temperature values corresponding to respective ones of the plurality of physical blocks.

9. A computer-implemented method comprising:
measuring a program temperature associated with a virtual block (VB);
measuring a read temperature associated with the VB;
determining, based at least in part on the measured program temperature and the measured read temperature, a cross-temperature condition; and
based on the determined cross-temperature condition, determining an adjusted voltage, the adjusted voltage including one or more of: an adjusted pass through voltage (Vpassr), an adjusted bit line (BL) bias voltage, or an adjusted source line (SL) voltage.

10. The computer-implemented of claim 9, wherein the adjusted voltage is an adjusted Vpassr and the VB includes a plurality of virtual wordlines (VWLs) and a plurality of bitlines (BLs), the method including:
performing a read operation at least in part by—
applying a read voltage to a first VWL of the plurality of VWLs,
applying the adjusted Vpassr to one or more remaining VWLs of the plurality of VWLs.

11. The computer-implemented of claim 9, wherein the adjusted voltage is an adjusted BL bias voltage, the VB including a plurality of virtual wordlines (VWLs) and a plurality of bitlines (BLs), the method including:
performing a read operation at least in part by—
applying a read voltage to a first VWL of the plurality of VWLs,
applying the adjusted BL bias voltage to one or more of the plurality of BLs.

12. The computer-implemented of claim 9, wherein the adjusted voltage is an adjusted SL voltage and the VB includes a plurality of virtual wordlines (VWLs) and a plurality of physical blocks, the method including:
performing a read operation at least in part by—
applying a read voltage to a first VWL of the plurality of VWLs,
applying the adjusted SL voltage to one or more of the plurality of physical blocks.

13. The computer-implemented of claim 9, the VB including a bit line (BL), the BL including a string of cells electrically connected in series, the adjusted voltage to adjust a string current (Icell) of the string of cells.

14. The computer-implemented of claim 9, the VB including a plurality of physical blocks, the measured program temperature including an aggregation of program temperature values corresponding to respective ones of the plurality of physical blocks, the measured read temperature including an aggregation of read temperature values corresponding to respective ones of the plurality of physical blocks.

15. Non-transitory computer readable media having instructions stored thereon, that when executed by at least one processor, cause the at least one processor to:
measure a program temperature associated with a virtual block (VB);
measure a read temperature associated with the VB;
determine, based at least in part on the measured program temperature and the measured read temperature, a cross-temperature condition; and
based on the determined cross-temperature condition, determine an adjusted voltage, the adjusted voltage including one or more of: an adjusted pass through voltage (Vpassr), an adjusted bit line (BL) bias voltage, or an adjusted source line (SL) voltage.

16. The non-transitory computer readable media of claim 15, wherein the adjusted voltage is an adjusted Vpassr and the VB includes a plurality of virtual wordlines (VWLs), the instructions, when executed by the at least one processor, causing the at least one processor to:
perform a read operation at least in part by—
applying a read voltage to a first VWL of the plurality of VWLs,
applying the adjusted Vpassr to one or more remaining VWLs of the plurality of VWLs.

17. The non-transitory computer readable media of claim 15, wherein the adjusted voltage is an adjusted BL bias voltage and the VB includes a plurality of virtual wordlines (VWLs) and a plurality of bitlines (BLs), the instructions, when executed by the at least one processor, causing the at least one processor to:
perform a read operation at least in part by—
applying a read voltage to a first VWL of the plurality of VWLs,
applying the adjusted BL bias voltage to one or more of the plurality of BLs.

18. The non-transitory computer readable media of claim 15, wherein the adjusted voltage is an adjusted SL voltage and the VB includes a plurality of virtual wordlines (VWLs) and a plurality of physical blocks, the instructions, when executed by the at least one processor, causing the at least one processor to:
perform a read operation at least in part by—
applying a read voltage to a first VWL of the plurality of VWLs,
applying the adjusted SL voltage to one or more of the plurality of physical blocks.

19. The non-transitory computer readable media of claim 15, the VB including a bit line (BL), the BL including a string of cells electrically connected in series, the adjusted voltage to adjust a string current (Icell) of the string of cells.

20. The non-transitory computer readable media of claim 19, the VB including a plurality of physical blocks, the measured program temperature including an aggregation of program temperature values corresponding to respective ones of the plurality of physical blocks, the measured read temperature including an aggregation of read temperature values corresponding to respective ones of the plurality of physical blocks.
